(19) United States
(12) Patent Application Publication
(10) Pub. No.: US 2002/0068209 A1
(43) Pub. Date: Jun. 6, 2002

(54) Fuel cell system for a motor vehicle

(76) Inventors: Stefan Boneberg, Beuren (DE); Martin Karl, Neidlingen (DE); Thomas Roeser, Dettingen/Teck (DE); Martin Schuessler, Ulm (DE); Detlef Zur Megede, Kirchheim/Teck (DE)

Correspondence Address: CROWELL & MORING, L.L.P., Intellectual Property Group, P.O. Box 14300, Washington, DC, 20044-4300, US

(21) Appl. No.: 09/978,783

(22) Filed: Oct. 18, 2001

(30) Foreign Application Priority Data
Oct. 18, 2000 (DE) 100 51 664.5

(51) Int. Cl. H01M 8/04

(52) U.S. Cl. 429/34; 429/19; 429/13

(57) ABSTRACT

A fuel cell system for a motor vehicle, with at least one fuel cell and with a gas generation system, has at least one device for cleaning the air that is taken in. The device is arranged in an area in front of the cathode chamber of at least one fuel cell and/or in an area in front of a gas generation system, and contains at least one element for adsorption of ions and/or hydrocarbons.

### BACKGROUND AND SUMMARY OF THE INVENTION

This application claims the priority of German patent document 100 51 664.5, filed Oct. 18, 2000, the disclosure(s) of which is (are) expressly incorporated by reference herein.

The invention relates to a fuel cell system for a motor vehicle with at least one fuel cell and a gas generation system.

In a generic fuel cell system disclosed in German patent document DE 198 47 985 C1, a conducting agent is arranged in a container that holds an operating means for the operation of the fuel cell, the container preferably also being suited for methanol with a lower degree of purity.

European patent document EP 0 677 417 A1 describes the usage of an air filter in a vehicle that is equipped with a fuel cell; and the filtration of air that is fed to the fuel cell is also described in GB 2 250 130 A.

When motor vehicles equipped with such fuel cell systems are operated in traffic, difficulties of unknown origin have frequently been observed in the gas generation system, or also in the fuel cell itself. Such difficulties are often associated with an unsatisfactorily brief service life of the catalysts in the components of the gas generation system of such fuel cell systems, which in turn has led to experiments to develop new designs and/or coatings. These efforts, however, have not eliminated such problems or their cause.

Surprisingly it has been found that the catalysts are damaged or destroyed by so-called catalytic poisons, such as hydrocarbons or chlorides; therefore, it follows that the above-mentioned contamination must exist in the air taken in and required by the fuel cell system. Since chlorides are observed in components with catalysts more frequently in winter, it is most likely that they were able to reach the air taken in due to the spreading of salt on the roads. Vapors of hydrocarbons (for example, especially higher volatile hydrocarbons) can exist as contamination in the air that is taken in, or can reach the air in the vehicle itself (e.g., in the form of compressor oil). As already mentioned above, such catalytic poisons can destroy catalysts in the gas generation system, leading not only to a shorter service life, but also to potential vehicle failures. Furthermore, the above-mentioned substances also attack the membranes of the individual fuel cells and impair their function.

It is therefore an object of the present invention to create a fuel cell system for a motor vehicle in which the fuel cell itself, or the gas generation system, is supplied with air that does not have a damaging effect on the components of the fuel cell system.

This and other objects and advantages are achieved by the fuel cell system according to the invention, in which at least one device for cleaning intake air is arranged upstream of the cathode chamber of the fuel cell and/or upstream of a gas generation, system. The device for cleaning intake air contains at least one element for adsorption of ions and/or hydrocarbons. As a result, the above-mentioned substances, which are extremely damaging for the catalysts and/or the membranes of such fuel cell systems, are removed from the air that is taken in before it enters a gas generation system and/or the fuel cell. Thus, damage is avoided, and the fuel cell system can be operated without defects.

Such a cleaning device is extremely beneficial, particularly when using motor vehicles with fuel cell power on roads in the winter, because chlorides reaching the intake air due to the salt are eliminated. In addition, the invention is also very beneficial for use in motor vehicles that are operated in an environment that exhibits a relatively high oil content in the air (e.g., forklifts in warehouses) in connection with the service life of the entire fuel cell system, if this causes higher volatile hydrocarbons (i.e., fats) to be removed from the air that is taken in.

Ion exchange resins have proven particularly beneficial in the removal of anions and/or cations, such as chlorides or sodium ions, which in a beneficial embodiment of the invention can represent an element of the device for cleaning the air that is taken in.

In an additional beneficial embodiment, another element of the device for cleaning the air that is taken in can be an activated carbon element, which is in a position to remove hydrocarbons from the air that is taken in.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic diagram of a fuel cell system for a motor vehicle, including the device according to the invention for cleaning the air that is taken in;

FIG. 2 shows a first embodiment of a device for cleaning the air;

FIG. 3 shows a second embodiment of a device for cleaning the air;

FIG. 4 shows a third embodiment of a device for cleaning the air.

### DETAILED DESCRIPTION OF THE DRAWINGS

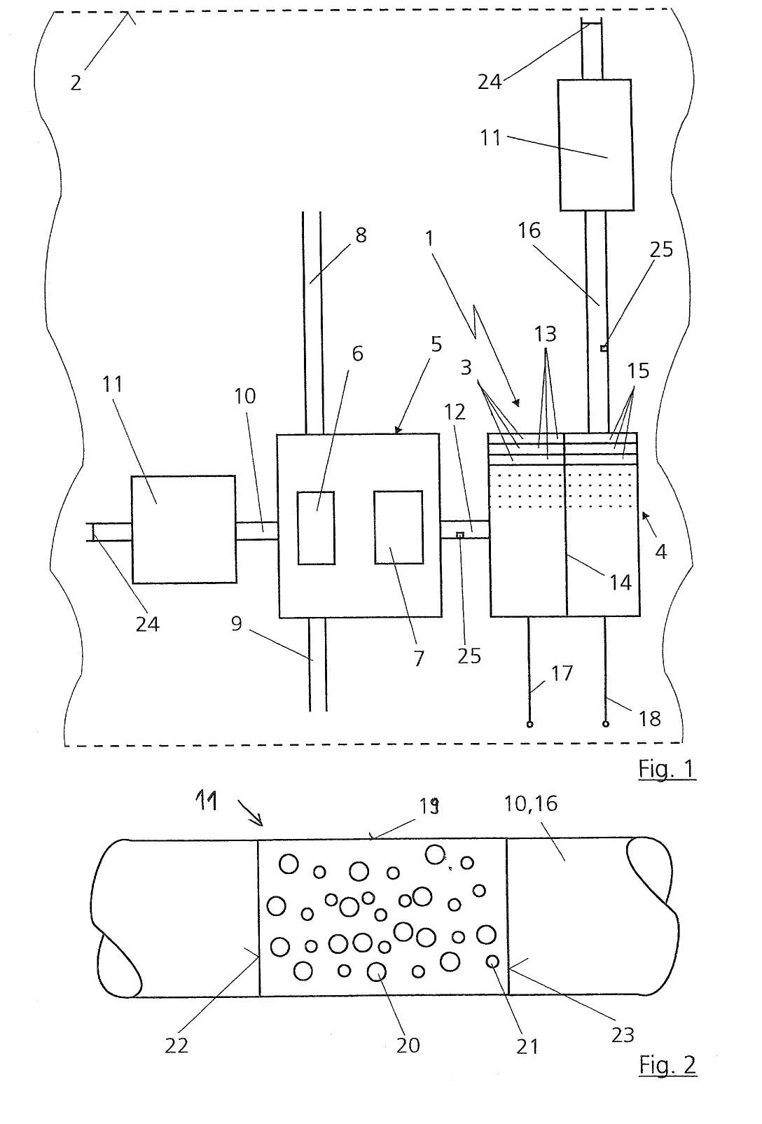

FIG. 1 depicts a fuel cell system 1 for a motor vehicle 2, which is indicated only in part and with dotted lines. The fuel cell system 1 is equipped with a conventional fuel cell stack 4 consisting of several fuel cells 3 as well as with a gas generation system 5, in which conventionally hydrogen-containing gas is generated from methanol and water for the fuel cell stack 4.

The gas generation system 5 (whose exact operation is well known, and hence is not described in detail in the following) includes a reformer 6 and a catalytic combustion unit 7, apart from various other familiar components, and has a feed line 8 for water and a feed line 9 for methanol. An air feed line 10, provided with a device 11 for cleaning the air that is taken in (described in more detail below), leads to the gas generation system 5.

A feed line 12 feeds generated hydrogen-containing gas from the gas generation system 5 to the fuel cell stack 4, entering the anode chambers 13 of the fuel cells 3, while an air feed line 16 enters the cathode chambers 15 (which are separated from the anode chambers 13 by a proton-guiding membrane 14). The feed line 16 also contains a device 11 such as described above, for cleaning the air that is taken in. Electrical lines 17 and 18, respectively, extend from the anode chambers 13 and the cathode chambers 15, from which the current generated by the individual fuel cells 3 and/or by the fuel cell stack 4 is taken.

FIG. 2 shows a first embodiment of the device 11 for cleaning the air that is taken in, which can be located in one or also in both feed lines 10 and/or 16. It includes a housing 19, whose diameter is adapted to the respective feed line 10 and/or 16, and which houses an element 20 for the adsorption of ions from the air that is taken in (i.e., an ion exchange element 20 consisting of ion exchange resin). Furthermore, an element 21, in the form of an activated carbon element 21, is arranged in the housing 19 for the adsorption of hydrocarbons from the air that is taken in.

The ion exchange element 20 and the activated carbon element 21 are piled in the housing 19, with the ion exchange element 20 containing ion exchange resin balls and the activated carbon element 21 being in granular or pellet form. Alternatively, the ion exchange element 20 may be provided in the form of a coating of an ion exchange resin arranged on a carrier element with large surface. The housing 19 is bounded on both sides with closure screens 22 and 23.

Instead of the described version in the form of a piled arrangement of the ion exchange element 20 and the activated carbon element 21, of course, it is also possible to provide the two elements 20 and 21 in several layers or zones.

The ion exchange element 20 makes it possible to remove all anions (such as chlorides) and all cations (such as sodium ions) from the air that is taken in. Of course, it is also possible in this context to use separate ion exchange elements 20 for anions and for cations. The activated carbon element 21 on the other hand serves the purpose of removing hydrocarbons, particularly higher volatile hydrocarbons (fats and oils), from the air that is taken in. The ion exchange element 20 and the activated carbon element 21 operate independently from each other.

In order to prevent the penetration of coarse, particularly mechanical, contamination into the cleaning device 11, a filtration element 24 is arranged upstream (relative to the flow direction of the air) of the ion exchange element 20 or upstream of the activated carbon element 21. Additionally, a sensor 25 for measuring the quantity of ions and/or hydrocarbons in the air that is taken in is arranged downstream (relative to the flow direction of the air) of the device 11 for cleaning the air that is taken in, so that the cleaning effect of the device 11 and/or its elements 20 can be determined and they can be replaced if necessary. Another way of determining the cleaning effect of the ion exchange element 20 is to have it change color, depending on its load state.

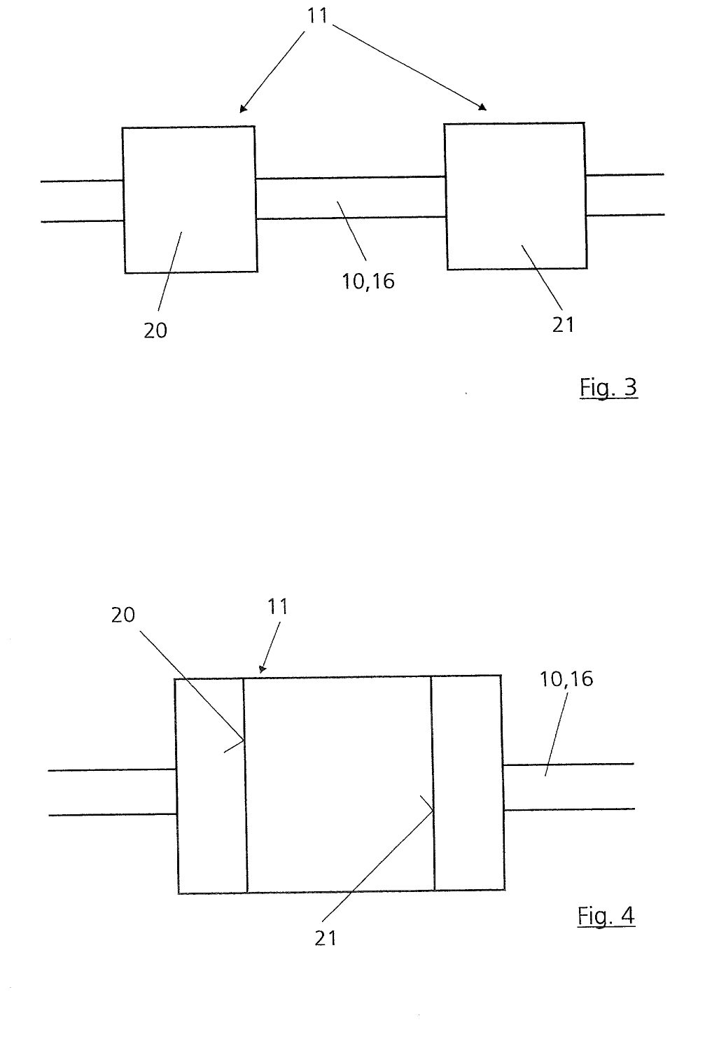

Another embodiment of the device 11 for cleaning the intake air for one or both feed lines 10 and/or 16, is shown in FIG. 3, in which the elements 20 and 21 are once again an ion exchange element and activated carbon element, respectively. However, unlike the embodiment pursuant to FIG. 2, the two elements 20 and 21 are spatially separated from each other, with the flow of air passing initially through the ion exchange element 20, and then through the activated carbon element 21. In this configuration ions are first removed from the intake air, while of higher volatile hydrocarbons, which can reach the intake air behind the ion exchange element 20 possibly through various devices in the flow direction, are not removed until right before the gas generation system 5 and/or the fuel cell stack 4.

In another embodiment of the device 11 for cleaning the intake air, shown in FIG. 4, the elements 20 and 21 are designed as semi-permeable membranes, which allow air to penetrate. The membrane 20 however prevents the continued flow of ions, while the membrane 21 retains hydrocarbons, cleaning the air in the feed lines 10 and/or 16 as in the embodiments and examples described above.

In a further embodiment (not shown), the ion exchange element 20 could also take the form of an electrostatic or capacitive ion exchange element 20.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A fuel cell system for a motor vehicle, with at least one fuel cell, wherein:
at least one device for cleaning air that is taken into the fuel cell system is arranged in an area that is one of upstream of a cathode chamber of the at least one fuel cell and upstream of a gas generation system of the fuel cell system; and
said at least one device contains at least one element for the adsorption of at least one of ions and hydrocarbons.

2. The fuel cell system according to claim 1, wherein the device for cleaning the air contains an ion exchange element for at least one of anions and cations.

3. The fuel cell system according to claim 2, wherein the ion exchange element comprises a piled arrangement of ion exchange resin balls.

4. The fuel cell system according to claim 2, wherein the ion exchange element comprises a coating of an ion exchange resin on a carrier element with a large surface.

5. The fuel cell system according to claim 2, wherein the ion exchange element comprises an electrostatic ion exchange element.

6. The fuel cell system according to claim 2, wherein the ion exchange element comprises a capacitive ion exchange element.

7. The fuel cell system according to claim 2, wherein the device for cleaning the air further comprises an activated carbon element.

8. The fuel cell system according to claim 7, wherein the device for cleaning the air comprises a housing, in which the ion exchange element and the activated carbon element are arranged in a pile.

9. The fuel cell system according to claim 7, wherein the ion exchange element and the activated carbon element are spatially separated from each other.

10. The fuel cell system according to claim 1, wherein the device for cleaning the air contains a semi-permeable membrane, which is impenetrable for ions.

11. The fuel cell system according to claim 1, wherein the device for cleaning the air contains a semi-permeable membrane, which is impenetrable to hydrocarbons.

12. The fuel cell system according to claim 1, wherein a filtration element is arranged upstream of the at least one element for the adsorption of at least one of ions and hydrocarbons, for filtering out coarse contamination.

13. The fuel cell system according to claim 1, wherein a sensor is arranged downstream the device for cleaning the air, for measuring particles of at least one of ions and hydrocarbons in the air taken in.

14. A fuel cell system for a motor vehicle, comprising:
at least one fuel cell having a cathode chamber and an anode chamber;
an air input to said cathode chamber;
a gas generator for supplying a gaseous fuel to said at least one fuel cell; and
at least one device for cleaning air taken into the fuel cell system, arranged in an area that is upstream of at least one of said air input to said cathode chamber and an air intake of said gas generator;
wherein said at least one device contains at least one element for adsorption of at least one of ions and hydrocarbons.

15. A method of operating a fuel cell system for a motor vehicle having a fuel cell, comprising:
processing air that is taken into the fuel cell system, by causing adsorption of at least one of ions and hydrocarbons in said air.

16. The method according to claim 15, wherein said step of processing air that is taken into the fuel cell system is performed for at least one of air taken into a gas generator for providing gaseous fuel for said fuel cell, and air that is taken into a cathode of said fuel cell.
